(19) United States
(12) Patent Application Publication
(10) Pub. No.: US 2025/0131838 A1
(43) Pub. Date: Apr. 24, 2025

(54) PRIORITY BASED FREQUENCY ALLOCATION IN A COLLISION DETECTION SYSTEM

(71) Applicant: NEWTRAX TECHNOLOGIES INC., Montreal (CA)

(72) Inventors: Martin BOUCHARD, Montreal (CA); Fabricio CORREA, Montreal (CA); Ngoma EMEKA, Montreal (CA)

(21) Appl. No.: 18/835,063

(22) PCT Filed: Feb. 1, 2023
(86) PCT No.: PCT/IB2023/050875

§ 371 Date: Aug. 1, 2024

Related U.S. Application Data
(60) Provisional application No. 63/305,773, filed on Feb. 2, 2022.

(51) Int. Cl. G08G 9/02; E21F 17/18

(52) U.S. Cl. CPC G08G 9/02; E21F 17/18

(57) ABSTRACT

An apparatus, method, and computer program product arranged to determine a communication frequency and communicate with a collision detection device at the determined communication frequency based on collision risk.

### RELATED APPLICATIONS

The present application claims the benefits of priority of U.S. Provisional Patent Application No. 63/305,773; entitled “COLLISION DETECTION”; and filed at the United States Patent and Trademark Office on Feb. 2, 2022; the content of which is incorporated herein by reference.

### TECHNICAL FIELD

The present application relates generally to collision detection. More specifically, the present application relates to determining a communication frequency for communicating with a collision detection device.

### BACKGROUND

Mobile mining machines operate in varying circumstances. A mining environment is a challenging operating environment in terms of risks of collision due to limited space, limited light, and limited connectivity.

### SUMMARY

According to a first aspect, there is provided a collision detection apparatus comprising at least one processor and at least one memory including computer program instructions, the at least one memory and the computer program instructions configured to, with the at least one processor, cause the apparatus at least to detect a first collision detection device and a second collision detection device in the vicinity of the collision detection apparatus, communicate with the first collision detection device by transmitting and/or receiving first collision detection messages, communicate with the second collision detection device by transmitting and/or receiving second collision detection messages, determine, based on the first collision detection messages, a first collision indicator, determine, based on the second collision detection messages, a second collision indicator, determine a priority order for the first collision detection device and the second collision detection device based on the first collision indicator and the second collision indicator, determine, based on the priority order, a first communication frequency for communicating with the first collision detection device and a second communication frequency for communicating with the second collision detection device, and communicate with the first collision detection device at the first communication frequency and with the second collision detection device at the second communication frequency, the first communication frequency being different from the second communication frequency.

According to a second aspect, there is provided a method in a collision detection apparatus, the method comprising detecting a first collision detection device and a second collision detection device in the vicinity of the collision detection apparatus, communicating with the first collision detection device by transmitting and/or receiving first collision detection messages, communicating with the second collision detection device by transmitting and/or receiving second collision detection messages, determining, based on the first collision detection messages, a first collision indicator, determining, based on the second collision detection messages, a second collision indicator, determining a priority order for the first collision detection device and the second collision detection device based on the first collision indicator and the second collision indicator, determining, based on the priority order, a first communication frequency for communicating with the first collision detection device and a second communication frequency for communicating with the second collision detection device, and communicating with the first collision detection device at the first communication frequency and with the second collision detection device at the second communication frequency, the first communication frequency being different from the second communication frequency.

According to a third aspect, there is provided a computer program comprising instructions for causing a collision detection apparatus to perform at least the following: detecting a first collision detection device and a second collision detection device in the vicinity of the collision detection apparatus, communicating with the first collision detection device by transmitting and/or receiving first collision detection messages, communicating with the second collision detection device by transmitting and/or receiving second collision detection messages, determining, based on the first collision detection messages, a first collision indicator, determining, based on the second collision detection messages, a second collision indicator, determining a priority order for the first collision detection device and the second collision detection device based on the first collision indicator and the second collision indicator, determining, based on the priority order, a first communication frequency for communicating with the first collision detection device and a second communication frequency for communicating with the second collision detection device, and communicating with the first collision detection device at the first communication frequency and with the second collision detection device at the second communication frequency, the first communication frequency being different from the second communication frequency.

According to a fourth aspect, there is provided a collision detection apparatus comprising means for performing at least the following: detecting a first collision detection device and a second collision detection device in the vicinity of the collision detection apparatus, communicating with the first collision detection device by transmitting and/or receiving first collision detection messages, communicating with the second collision detection device by transmitting and/or receiving second collision detection messages, determining, based on the first collision detection messages, a first collision indicator, determining, based on the second collision detection messages, a second collision indicator, determining a priority order for the first collision detection device and the second collision detection device based on the first collision indicator and the second collision indicator, determining, based on the priority order, a first communication frequency for communicating with the first collision detection device and a second communication frequency for communicating with the second collision detection device, and communicating with the first collision detection device at the first communication frequency and with the second collision detection device at the second communication frequency, the first communication frequency being different from the second communication frequency.

According to a fifth aspect, there is provided a non-transitory computer readable medium comprising program instructions for causing a collision detection apparatus to perform at least the following: detecting a first collision detection device and a second collision detection device in the vicinity of the collision detection apparatus, communicating with the first collision detection device by transmitting and/or receiving first collision detection messages, communicating with the second collision detection device by transmitting and/or receiving second collision detection messages, determining, based on the first collision detection messages, a first collision indicator, determining, based on the second collision detection messages, a second collision indicator, determining a priority order for the first collision detection device and the second collision detection device based on the first collision indicator and the second collision indicator, determining, based on the priority order, a first communication frequency for communicating with the first collision detection device and a second communication frequency for communicating with the second collision detection device, and communicating with the first collision detection device at the first communication frequency and with the second collision detection device at the second communication frequency, the first communication frequency being different from the second communication frequency.

According to a sixth aspect, there is provided a computer readable medium comprising program instructions for causing a collision detection apparatus to perform at least the following: detecting a first collision detection device and a second collision detection device in the vicinity of the collision detection apparatus, communicating with the first collision detection device by transmitting and/or receiving first collision detection messages, communicating with the second collision detection device by transmitting and/or receiving second collision detection messages, determining, based on the first collision detection messages, a first collision indicator, determining, based on the second collision detection messages, a second collision indicator, determining a priority order for the first collision detection device and the second collision detection device based on the first collision indicator and the second collision indicator, determining, based on the priority order, a first communication frequency for communicating with the first collision detection device and a second communication frequency for communicating with the second collision detection device, and communicating with the first collision detection device at the first communication frequency and with the second collision detection device at the second communication frequency, the first communication frequency being different from the second communication frequency.

This summary is not an extensive overview of all contemplated embodiments and is not intended to identify key or critical aspects or features of any embodiments or to delineate any embodiments. Other aspects and features will become apparent to those ordinarily skilled in the art upon review of the following description of specific embodiments with the figures.

### BRIEF DESCRIPTION OF THE FIGURES

Some example embodiments will now be described with reference to the accompanying figures:

FIG. 1 shows a block diagram of an example apparatus in which examples of the disclosed embodiments may be applied;

FIG. 2 shows a block diagram of another example apparatus in which examples of the disclosed embodiments may be applied;

FIG. 3 illustrates an example mine;

FIG. 4 shows an example of priority information;

FIG. 5 shows an example method incorporating aspects of example embodiments; and

FIG. 6 shows an example system architecture incorporating aspects of example embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Example embodiments relate to providing proximity detection such as collision detection. More particularly, example embodiments relate to determining a communication frequency for communicating with an object of interest.

An example embodiment relates to a collision detection apparatus configured to detect a first collision detection device and a second collision detection device in the vicinity of the collision detection apparatus, communicate with the first collision detection device by transmitting and/or receiving first collision detection messages, communicate with the second collision detection device by transmitting and/or receiving second collision detection messages, determine, based on the first collision detection messages, a first collision indicator, determine, based on the second collision detection messages, a second collision indicator, determine a priority order for the first collision detection device and the second collision detection device based on the first collision indicator and the second collision indicator, determine, based on the priority order, a first communication frequency for further communicating with the first collision detection device and a second communication frequency for further communicating with the second collision detection device, and communicate with the first collision detection device at the first communication frequency and with the second collision detection device at the second communication frequency, the first communication frequency being different from the second communication frequency.

FIG. 1 is a block diagram depicting an apparatus 100 operating in accordance with an example embodiment. The apparatus 100 may be, for example, an electronic device such as a module comprised by an automation or control system, a chip, or a chipset. The apparatus 100 comprises one or more control circuitry, such as at least one processor 110 and at least one memory 160, including one or more algorithms such as computer program instructions 120 wherein the at least one memory 160 and the computer program instructions are configured, with the at least one processor 110, to cause the collision detection apparatus to carry out any of example functionalities described below.

In the example of FIG. 1, the processor 110 is a control unit operatively connected to read from and write to the memory 160. The processor 110 may also be configured to receive control signals received via an input interface and/or the processor 110 may be configured to output control signals via an output interface. In an example embodiment, the processor 110 may be configured to convert the received control signals into appropriate commands for controlling functionalities of the apparatus 100.

The at least one memory 160 stores computer program instructions 120 which when loaded into the processor 110 control the operation of the apparatus 100 as explained below. In other examples, the apparatus 100 may comprise more than one memory 160 or different kinds of storage devices.

Computer program instructions 120 for enabling implementations of example embodiments or a part of such computer program instructions may be loaded onto the apparatus 100 by the manufacturer of the apparatus 100, by a user of the apparatus 100, or by the apparatus 100 itself based on a download program, or the instructions can be pushed to the apparatus 100 by an external device. The computer program instructions may arrive at the apparatus 100 via an electromagnetic carrier signal or be copied from a physical entity such as a computer program product, a memory device or a record medium such as a USB stick, a Compact Disc (CD), a Compact Disc Read-Only Memory (CD-ROM), a Digital Versatile Disk (DVD) or a Blu-ray disk.

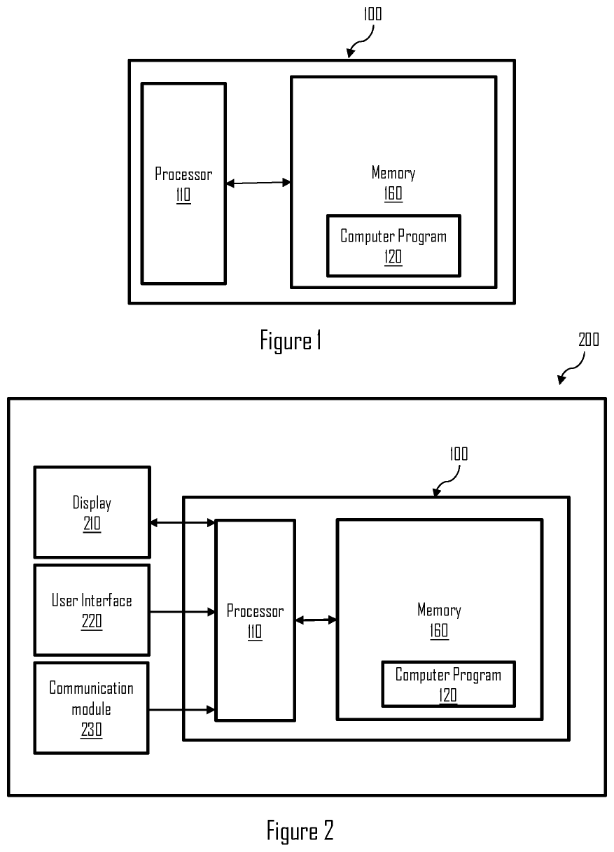

FIG. 2 is a block diagram depicting an apparatus 200 in accordance with an example embodiment. The apparatus 200 may be an electronic device such as a proximity or collision detection device, comprising a Personal Computer (PC), a laptop, a desktop, a wireless terminal, a communication terminal, a control apparatus, a computing device, a portable computing device, collision detection sensors, or the like. In the examples below it is assumed that the apparatus 200 is a computing device such as a collision detection apparatus.

In the example embodiment of FIG. 2, the apparatus 200 is illustrated as comprising the apparatus 100, a display 210, a user interface 220 for interacting with the apparatus 200, and a communication module 230.

The display 210 may also be configured to act as a user interface. For example, the display may be a touch screen display. In an example embodiment, the display 210 and/or the user interface 220 may be external to the apparatus 200, but in communication with it.

Additionally, or alternatively, the user interface 220 may also comprise a manually operable control such as a button, a key, a touch pad, a joystick, a stylus, a pen, a roller, a rocker, a keypad, a keyboard, or any suitable input mechanism for inputting and/or accessing information.

The communication module 230 may be configured to establish radio communication with another device using, for example, a cellular network connection, a Bluetooth connection, a Wi-Fi connection, an ultra-wide band (UWB) connection, a chirp-spread-spectrum (CSS) connection, and/or the like.

The communication module 230 may further be configured to process received information. For example, the communication module 230 may be configured to receive information from one or more collision detection sensors and/or determine a distance between the apparatus 200 and an object of interest based on the information received from the one or more collision detection sensors.

According to an example embodiment, the apparatus 200 comprises a collision detection device. The apparatus may be associated with an object of interest such as a mobile mining vehicle, a cap lamp of a miner, a fixed location such as a void in the ground or other location of interest. Mobile object is a sub type of object of interest and is used interchangeably throughout this text.

According to an example embodiment, a mobile mining vehicle comprises a rock drilling rig, a loader, a dumper, a load haul dump (LHD) vehicle, a ground support rig, an underground transport vehicle, a light duty vehicle, or any other vehicle or machine capable and/or configured to operate underground.

According to an example embodiment, the apparatus 200 is configured to communicate with one or more devices. For example, the apparatus 200 may be configured to communicate with a cloud server, a local server, an edge computing server, a mobile computing device, and/or different kinds of machinery, mobile objects such as mobile mining vehicles or miners carrying a collision detection device, or the like.

Communicating with a device may comprise, for example, transmitting and/or receiving information using a wireless or wired connection. According to an example embodiment, the apparatus 200 is configured to receive information from a plurality of collision detection sensors. The apparatus 200 may be configured to receive the information, for example, via the communication module 230.

According to an example embodiment, the apparatus 200 is configured to receive a radio frequency (RF) broadcast message emitted by a collision detection device. The collision detection device may comprise, for example, a collision detection device included in a mobile mining vehicle in an underground mine, or a collision detection device included in a cap lamp of a miner.

According to an example embodiment, the apparatus 200 is configured to receive radio frequency messages from a plurality of sources. The plurality of sources may comprise sources of a same type or different types of sources. For example, the plurality of sources may comprise, for example, collision detection devices included in different types of mobile mining vehicles and/or cap lamps.

According to an example embodiment, the apparatus 200 is configured to receive radio frequency broadcast messages from a first collision detection device and from a second collision detection device.

Without limiting the scope of the claims, an advantage of receiving a radio frequency message from a collision detection device is that the apparatus 200 is aware of the presence of the collision detection device.

The apparatus 200 may be configured to detect, based on a received radio frequency message, that a collision detection device is within a detection range of the apparatus 200. The apparatus 200 may be configured to determine that a collision detection device is in the vicinity of the apparatus 200 when the collision detection device is within a detection range of the apparatus 200.

According to an example embodiment, the apparatus 200 is configured to detect a first collision detection device and a second collision detection device in the vicinity of the apparatus

The apparatus 200 may be configured to initiate communication with a detected collision detection device upon detecting the collision detection device. For example, the apparatus 200 may be configured to initiate communication with a first collision detection device upon detecting the first collision detection device and with a second collision detection device upon detecting the second collision detection device. Initiating communication with a collision detection device may comprise, for example, sending messages to the collision detection device for initiating ranging.

Ranging comprises a process for measuring a distance between two nodes such as a distance between the apparatus 200 and a collision detection device. The apparatus 200 may be configured to determine the distance between the apparatus 200 and a collision detection device by performing ranging based on RF Time of Flight (ToF) such as two-way ranging (TWR), for example.

Ranging comprises exchanging messages between nodes such as the apparatus 200 and a collision detection device, and measuring parameters to estimate a range.

Ranging may comprise different types of messages such as a ranging request, a ranging response, and a ranging result.

A ranging request comprises at least identification (ID) information on the initiating device and a list of requested device IDs. The list of requested device IDs may comprise, for example, device IDs of collision detection devices detected by the apparatus 200. The list of requested device IDs may be limited to, for example, eight device IDs.

A ranging response comprises information on a responding device ID and the initiating device ID. For example, a ranging response may comprise a device ID of a first collision detection device and a device ID of the apparatus 200.

A ranging result comprises information on the initiating device ID and a list of responding device IDs with calculated distance to the initiating device. For example, a ranging result may comprise a device ID of the apparatus 200 and a device ID of first and second collision detection devices with calculated distances to the apparatus 200.

According to an example embodiment, the apparatus 200 is configured to communicate with the first collision detection device by transmitting and/or receiving first collision detection messages.

The first collision detection messages may comprise, for example, ranging requests transmitted by the collision detection apparatus 200 to the first collision detection device and/or ranging responses received by the apparatus 200 from the first collision detection device.

According to an example embodiment, the apparatus 200 is configured to communicate with the second collision detection device by transmitting and/or receiving second collision detection messages.

The second collision detection messages may comprise, for example, ranging requests transmitted by the collision detection apparatus 200 to the second collision detection device and/or ranging responses received by the apparatus 200 from the second collision detection device.

The apparatus 200 may be configured to transmit collision detection messages at a predetermined rate. The predetermined rate may be fixed or dynamic. A dynamic rate may depend upon, for example, the distance between the apparatus 200 and a collision detection device such as the first collision detection device or the second collision detection device. For example, when a distance between the apparatus 200 and a collision detection device is long, the predetermined rate may be low and when a distance between the apparatus 200 and a collision detection device is short, the predetermined rate may be high.

A low ranging rate may comprise a minimum rate to detect an approaching object in a particular environment and a high ranging rate may comprise a rate enabling quickly reacting to a collision threat in a particular environment.

A low rate may comprise, for example, a rate of 1 Hz and a high rate may comprise, for example, a rate of 4 Hz.

The apparatus 200 may be configured to determine, for example, based on predefined safety zones around a vehicle comprising the apparatus 200 when a distance between the apparatus 200 and a collision detection device is long or short.

As explained above, ranging comprises exchanging messages between nodes, such as the apparatus 200 and a collision detection device, and based on the messages the apparatus 200 may be configured to determine a distance between the apparatus 200 and the collision detection device.

According to an example embodiment, the apparatus 200 is configured to determine, based on one or more collision detection messages, a collision indicator. A collision indicator may comprise an indication of a likelihood or a threat level of a collision between a vehicle comprising the apparatus 200 and a mobile object comprising a collision detection device.

The apparatus 200 may be configured to determine a collision indicator for a plurality of detected collision detection devices such as the first collision detection device and the second collision detection device.

According to an example embodiment, the apparatus 200 is configured to determine, based on the first collision detection messages, a first collision indicator.

According to an example embodiment, the first collision indicator indicates a likelihood of a collision between a vehicle comprising the collision detection apparatus 200 and a mobile object comprising the first collision detection device.

According to an example embodiment, the apparatus 200 is configured to determine, based on the second collision detection messages, a second collision indicator.

According to an example embodiment, the second collision indicator indicates a likelihood of a collision between a vehicle comprising the collision detection apparatus 200 and a mobile object comprising the second collision detection device.

According to an example embodiment, determining a collision indicator comprises determining a speed of a collision detection device approaching the apparatus 200. The apparatus 200 may be configured to determine the speed of an approaching collision detection device based on a plurality of collision detection messages. For example, the apparatus 200 may be configured to determine the speed of an approaching collision detection device based on a rate of decreasing distance between the apparatus 200 and the collision detection device.

According to another example embodiment, determining a collision indicator comprises determining a distance between the collision detection device and the apparatus 200. The apparatus 200 may be configured to determine the distance of an approaching collision detection device based on one or more collision detection messages.

According to a further example embodiment, determining a collision indicator comprises determining a type of a mobile object comprising the collision detection device. For example, the apparatus 200 may be configured to determine a type of a mobile object based on an ID included in a collision detection message.

According to a yet further example embodiment, determining a collision indicator comprises a combination of determining a speed at which a collision detection device approaches the apparatus 200, determining a distance between the collision detection device and the apparatus 200 and/or determining a type of a mobile object comprising the collision detection device.

According to an example embodiment, determining the first collision indicator comprises at least one of the following: determining a speed at which the first collision detection device approaches the apparatus 200, determining a distance between the first collision detection device and the apparatus 200, or determining a type of a mobile object comprising the first collision detection device.

According to an example embodiment, determining the second collision indicator comprises at least one of the following: determining a speed at which the second collision detection device approaches the apparatus 200, determining a distance between the second collision detection device and the apparatus 200, or determining a type of a mobile object comprising the second collision detection device.

The apparatus 200 may be configured to use collision indicators for prioritizing mobile objects comprising collision detection devices.

According to an example embodiment, the apparatus 200 is configured to determine a priority order for the first collision detection device and the second collision detection device based on the first collision indicator and the second collision indicator.

A priority order of collision detection devices indicates a risk level of collisions. For example, there is a greater risk of a collision between the apparatus 200 and a mobile object comprising a collision detection device when the collision detection device has a high priority and a lower risk of a collision between the apparatus 200 and a mobile object when the collision detection device has a low priority.

According to an example embodiment, the apparatus 200 is configured to store information on the priority order. The apparatus 200 may be configured to store, for example, a table of collision devices associated with a priority number or an ordered list of collision detection devices. According to an example embodiment, the apparatus 200 is configured to update the

priority order in response to detecting that a collision indicator or a collision detection device has changed or the apparatus 200 has detected a new collision detection device that fulfills a predefined criterion. The criterion may be, for example, a risk indicator having a higher value than a predetermined threshold value, a risk indicator having a higher value than the lowest risk indicator among detected collision detection devices, or a rapidly increasing risk indicator value.

The apparatus 200 may be configured to communicate with a collision detection device based on the priority order. For example, the apparatus 200 may be configured to determine that a communication frequency for communicating with a collision detection device having a high priority should be high and a communication frequency for communicating with a collision detection device having a low priority should be low.

According to an example embodiment, the apparatus 200 is configured to determine, based on the priority order, a first communication frequency for communicating with the first collision detection device and a second communication frequency for communicating with the second collision detection device.

Determining a communication frequency may comprise selecting a communication frequency, adjusting a communication frequency, changing a communication frequency, maintaining a communication frequency, or the like.

According to an example embodiment, the apparatus 200 is configured to change a previous communication frequency of the apparatus 200 for communicating with the first collision detection device.

According to an example embodiment, the apparatus 200 is configured to change a previous communication frequency of the apparatus 200 for communicating with the second collision detection device.

According to an example embodiment, changing a previous communication frequency comprises increasing or decreasing the communication frequency.

The apparatus 200 may be configured to group collision detection sensors associated to the same mobile object.

According to an example embodiment, the apparatus 200 is configured to group collision detection sensors part of a collision detection device associated to a mobile object that shall be ranged at the same time.

Without limiting the scope of the claims, an advantage of grouping collision detection sensors part of a collision detection device associated to a mobile object is that they are ranged at the same time, to optimize the communication channel and have time aligned measurement of proximity for the sensors part of the collision detection device.

According to an example embodiment, the apparatus 200 is configured to transmit information at the determined communication frequency to a collision detection device for prompting the collision detection device to communicate with the apparatus 200 at the determined communication frequency. The information may comprise, for example, a ranging rate command.

The apparatus 200 may be configured to embed information on the determined communication frequency in one or more collision detection messages. For example, the apparatus 200 may be configured to include the information as additional bytes in user data. Therefore, the one or more collision detection messages may comprise a device ID of the apparatus 200, a device ID of a collision detection device and a rate at which the apparatus 200 expects to be ranged by the collision detection device.

According to an example embodiment, the apparatus 200 is configured to communicate with a collision detection device at the determined communication frequency.

According to an example embodiment, the apparatus 200 is configured to communicate with the first collision detection device at the first communication frequency and with the second collision detection device at the second communication frequency, the first communication frequency being different from the second communication frequency.

The apparatus 200 may be configured to monitor the communication with the first and second collision detection devices.

According to an example embodiment, the apparatus 200 is configured to monitor the communication with the first and the second collision detection devices for error rate.

According to an example embodiment, the apparatus 200 is further configured to autonomously reduce or re-establish the communication frequency. Re-establishing a communication frequency may comprise, for example, increasing the communication frequency back to the determined value.

Without limiting the scope of the claims, an advantage of monitoring the communication with the first and the second collision detection devices and autonomously reducing or re-establishing the communication frequency is that the error rate may be minimized, or at least reduced, and saturation of the communication channel may be avoided.

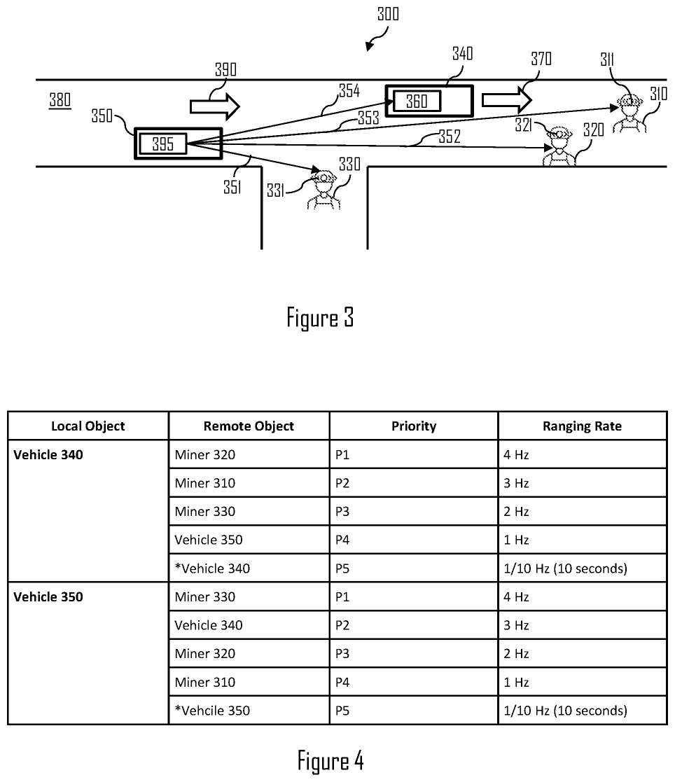

FIG. 3 illustrates an example use case. In the example of FIG. 3, a mobile mining vehicle 350 comprises a collision detection apparatus 395. The collision detection apparatus 395 may comprise the apparatus 200. The mobile mining vehicle 350 may comprise a rock drilling rig, a loader, a dumper, a load haul dump (LHD) vehicle, a ground support rig, or an underground transport vehicle.

The mining vehicle 350 is travelling in a mine 380 to a direction indicated by arrow 390. In addition to the mining vehicle 350, there are a plurality of objects of interest in the mine 380. In the example of FIG. 3, the objects of interest comprise miners 310, 320 and 330, and a mining vehicle 340. Each of the miners 310, 320 and 330 are carrying a collision detection device 311, 321 and 331, respectively, integrated in a cap lamp. Similarly to the mining vehicle 350, the mining vehicle 340 comprises a collision detection device 360.

The apparatus 395 is configured to detect the mobile objects 310, 320, 330 and 340 and perform ranging for determining distance 351 between the apparatus 395 and collision detection device 331, distance 352 between the apparatus 395 and collision detection device 321, distance 353 between the apparatus 395 and collision detection device 311, and distance 354 between the apparatus 395 and collision detection device 360.

The apparatus 395 is further configured to determine collision indicators for the collision detection device 311, 321, 331 and 360, and determine a priority order for the collision detection devices 311, 321, 331 and 360 based on the collision indicators.

The apparatus 395 is further configured to determine communication frequencies for communicating with the collision detection devices 311, 321, 331 and 360.

FIG. 4 illustrates an example of priority information stored by the apparatus 200. The priority information comprises identification information of the mobile objects, the priority of the mobile objects. The priority of a mobile object is indicated by a scale of PI to P4, where P1 corresponds to the highest priority and P4 corresponds to the lowest priority. In the example of FIG. 4, the priority information also comprises information on a communication frequency for communicating with collision detection sensors associated with the vehicle itself.

FIG. 5 illustrates an example method 500 incorporating aspects of the previously disclosed embodiments. More specifically, the example method 500 illustrates determining at least one communication frequency for communicating with at least one mobile object. The method may comprise a computer-implemented method performed by the apparatus 200.

The method starts with detecting 505 a first collision detection device and a second collision detection device in the vicinity of the collision detection apparatus.

The apparatus 200 may be configured to detect, based on a received radio frequency message, that a collision detection device is within a detection range of the apparatus 200. The apparatus 200 may be configured to determine that a collision detection device is in the vicinity of the apparatus 200 when the collision detection device is within a detection range of the apparatus 200.

The method continues with communicating 510 with the first collision detection device by transmitting and/or receiving first collision detection messages and communicating 515 with the second collision detection device by transmitting and/or receiving second collision detection messages.

As explained above, the first collision detection messages and the second collision detection messages may comprise, for example, ranging requests, ranging responses, or ranging results.

The method further continues with determining 520, based on the first collision detection messages, a first collision indicator, and determining 525, based on the second collision detection messages, a second collision indicator.

The first collision indicator indicates a likelihood of a collision between a vehicle comprising the collision detection apparatus and a mobile object comprising the first collision detection device. The second collision indicator indicates a likelihood of a collision between a vehicle comprising the collision detection apparatus and a mobile object comprising the second collision detection device.

The method further continues with determining 530 a priority order for the first collision detection device and the second collision detection device based on the first collision indicator and the second collision indicator.

A priority order of collision detection devices indicates a risk level of collisions. For example, there is a greater risk of a collision between the apparatus 200 and a mobile object comprising a collision detection device when the collision detection device has a high priority and a lower risk of a collision between the apparatus 200 and a mobile object when the collision detection device has a low priority.

The method further continues with determining 535, based on the priority order, a first communication frequency for further communicating with the first collision detection device and a second communication frequency for further communicating with the second collision detection device.

Determining a communication frequency may comprise selecting a communication frequency, adjusting a communication frequency, changing a communication frequency, maintaining a communication frequency, or the like.

The method further continues with communicating 540 with the first collision detection device at the first communication frequency and with the second collision detection device at the second communication frequency, the first communication frequency being different from the second communication frequency.

The method may further comprise monitoring the communication with the first and second collision detection devices. For example, the apparatus 200 may monitor the communication with the first and the second collision detection devices for error rate and autonomously reduce or re-establish the communication frequency in order for the error rate to be minimized, or at least reduced, and in order for saturation of the communication channel to be avoided.

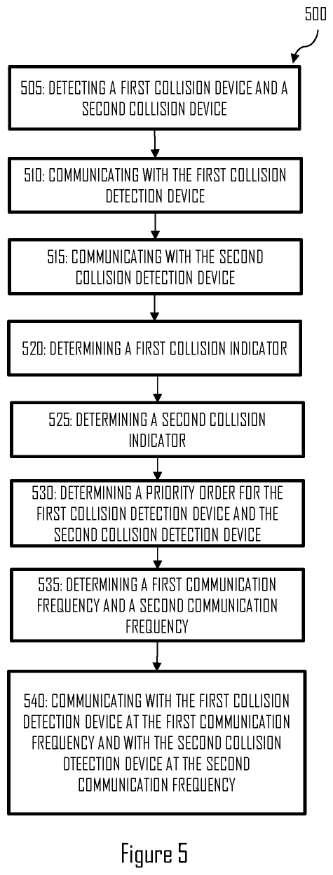

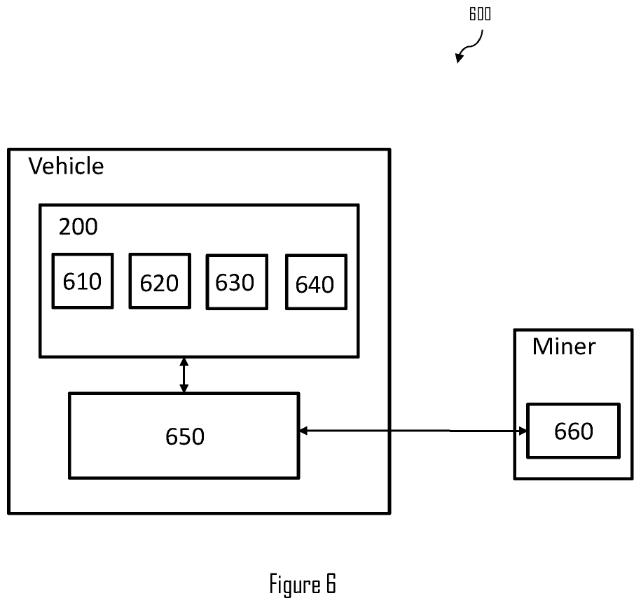

FIG. 6 illustrates an example system architecture. In the example of FIG. 6, a vehicle such as a mobile mining vehicle comprises the apparatus 200 and a communication module 650 for exchanging information with at least one mobile object such as a communication module 660 of a miner.

The apparatus 200 comprises a remote object table 610, location engine 620, prioritization engine 630 and a remote object table 640 sorted by priority. The remote object table 610 may comprise information on detected mobile object in the vicinity of the apparatus 200. The location engine 620 may be configured to perform ranging and store information on distances between the apparatus 200 and the remote objects. The prioritization engine 630 may be configured to determine collision indicators for the mobile objects, prioritize the mobile objects based on the collision indicators and sort the remote object table based on the priorities of the mobile objects.

Without limiting the scope of the claims, an advantage of determining priority information and determining a communication frequency based on the priority order is that the apparatus may detect critical situations and react to them more quickly.

Without in any way limiting the scope, interpretation, or application of the claims appearing below, a technical effect of one or more of the example embodiments disclosed herein is that the radio channel may be optimized.

As used in this application, the term “circuitry” may refer to one or more or all of the

following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments according to the present description may be implemented in software, hardware, application logic or a combination of software, hardware and application logic. The software, application logic and/or hardware may reside on the apparatus, a separate device or a plurality of devices. If desired, part of the software, application logic and/or hardware may reside on the apparatus, part of the software, application logic and/or hardware may reside on a separate device, and part of the software, application logic and/or hardware may reside on a plurality of devices. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

The above-described embodiments are examples only. Alterations, modifications, and/or variations may be effected to the particular embodiments by those skilled in the art without departing from the scope of the description.

1. A collision detection apparatus comprising at least one processor and at least one memory including computer program instructions, the at least one memory and the computer program instructions configured to, with the at least one processor, cause the apparatus at least to:
detect a first collision detection device and a second collision detection device in a vicinity of the collision detection apparatus;
communicate with the first collision detection device by transmitting and/or receiving first collision detection messages;
communicate with the second collision detection device by transmitting and/or receiving second collision detection messages;
determine, based on the first collision detection messages, a first collision indicator;
determine, based on the second collision detection messages, a second collision indicator;
determine a priority order for the first collision detection device and the second collision detection device based on the first collision indicator and the second collision indicator;
determine, based on the priority order, a first communication frequency for communicating with the first collision detection device and a second communication frequency for communicating with the second collision detection device; and
communicate with the first collision detection device at the first communication frequency and with the second collision detection device at the second communication frequency, the first communication frequency being different from the second communication frequency.

2. The apparatus according to claim 1, wherein the first collision indicator indicates a likelihood of a collision between a vehicle including the collision detection apparatus and a mobile object including the first collision detection device.

3. The apparatus according to claim 1, wherein the second collision indicator indicates a likelihood of a collision between a vehicle including the collision detection apparatus and a mobile object including the second collision detection device.

4. The apparatus according to claim 1, wherein determining the first collision indicator comprises at least one of the following: determining a speed at which the first collision detection device approaches the collision detection apparatus, determining a distance between the first collision detection device and the collision detection apparatus, or determining a type of a mobile object including the first collision detection device.

5. The apparatus according to claim 1, wherein determining the second collision indicator comprises at least one of the following: determining a speed at which the second collision detection device approaches the collision detection apparatus, determining a distance between the second collision detection device and the collision detection apparatus, or determining a type of a mobile object including the second collision detection device.

6. The apparatus according to claim 1, wherein the at least one memory and the computer program instructions are configured to, with the at least one processor, cause the apparatus to change at least one of the following: a previous communication frequency of the collision detection apparatus for communicating with the first collision detection device or a previous communication frequency of the collision detection apparatus for communicating with the second collision detection device.

7. The apparatus according to claim 6, wherein changing a previous communication frequency comprises increasing or decreasing the communication frequency.

8. The apparatus according to claim 1, wherein the at least one memory and the computer program instructions are configured to, with the at least one processor, cause the apparatus to store information on the priority order.

9. The apparatus according to claim 1, wherein the at least one memory and the computer program instructions are configured to, with the at least one processor, cause the apparatus to receive information from a plurality of collision detection sensors.

10. The apparatus according to claim 1, wherein the at least one memory and the computer program instructions are configured to group collision detection sensors part of a collision detection device associated to a mobile object that shall be ranged at the same time.

11. The apparatus according to claim 1, wherein the at least one memory and the computer program instructions are configured to, with the at least one processor, cause the apparatus to monitor the communication with first and second collision detection devices for error rate, and to autonomously reduce or re-establish the communication frequency.

12. The apparatus according to claim 1, wherein the apparatus is included in a mobile mining vehicle.

13. The apparatus according to claim 12, wherein the mobile mining vehicle is selected from a rock drilling rig, a loader, a dumper, a load haul dump (LHD) vehicle, a ground support rig, an underground transport vehicle, and a light duty vehicle.

14. A method in a collision detection apparatus, the method comprising:
detecting a first collision detection device and a second collision detection device in a vicinity of the collision detection apparatus;
communicating with the first collision detection device by transmitting and/or receiving first collision detection messages;
communicating with the second collision detection device by transmitting and/or receiving second collision detection messages;
determining, based on the first collision detection messages, a first collision indicator;
determining, based on the second collision detection messages, a second collision indicator;
determining a priority order for the first collision detection device and the second collision detection device based on the first collision indicator and the second collision indicator;
determining, based on the priority order, a first communication frequency for communicating with the first collision detection device and a second communication frequency for communicating with the second collision detection device; and
communicating with the first collision detection device at the first communication frequency and with the second collision detection device at the second communication frequency, the first communication frequency being different from the second communication frequency.

15. A computer program comprising instructions for causing a collision detection apparatus to perform at least the following:
detecting a first collision detection device and a second collision detection device in a vicinity of the collision detection apparatus;
communicating with the first collision detection device by transmitting and/or receiving first collision detection messages;
communicating with the second collision detection device by transmitting and/or receiving second collision detection messages;
determining, based on the first collision detection messages, a first collision indicator;
determining, based on the second collision detection messages, a second collision indicator;
determining a priority order for the first collision detection device and the second collision detection device based on the first collision indicator and the second collision indicator;
determining, based on the priority order, a first communication frequency for communicating with the first collision detection device and a second communication frequency for communicating with the second collision detection device; and
communicating with the first collision detection device at the first communication frequency and with the second collision detection device at the second communication frequency, the first communication frequency being different from the second communication frequency.
